(19) United States
(12) Patent Application Publication
(10) Pub. No.: US 2026/0049966 A1
(43) Pub. Date: Feb. 19, 2026

(54) MANUFACTURING METHOD TO PREVENT TOF (TIME OF FLIGHT) FAIL IN PROBE ACQUISITION INSPECTION

(71) Applicant: GE Precision Healthcare LLC, Waukesha, WI (US)

(72) Inventor: Shingo Fukazawa, Hino (JP)

(21) Appl. No.: 19/299,187

(22) Filed: Aug. 13, 2025

(30) Foreign Application Priority Data
Aug. 13, 2024 (JP) 2024-135128

(51) Int. Cl. G01N 29/24; G01N 29/06

(52) U.S. Cl. CPC G01N 29/245; G01N 29/0618; G01N 29/069

(57) ABSTRACT

A transducer element for an ultrasound probed that is disposed on a base block includes a first portion having a first curvature and a second portion having a second curvature with a radius shorter than the first curvature. The transducer element includes an FPC disposed across the first portion and the second portion and a laminate including a transducer disposed on the FPC. The laminate including the transducer includes a layer of a piezoelectric element, wherein the laminate including the transducer includes a relatively shallow groove that does not completely cut the layer of the piezoelectric element and a relatively deep groove that completely cuts the layer of the piezoelectric element, the relatively shallow groove and the relatively deep groove are alternately disposed at a position corresponding to the first portion, and a plurality of the relatively deep grooves are contiguously disposed at a position corresponding to the second portion.

### CROSS-REFERENCE TO RELATED APPLICATION

This application claim priority to Japanese Patent Application No. 2024-135128, which was file on Aug. 13, 2024 at the Japanese Patent Office. The entire contents of the above-listed application are incorporated by reference herein in their entirety.

### TECHNICAL FIELD

The present invention relates to an ultrasonic probe, and more particularly, to a transducer element including a transducer that converts high-frequency power into ultrasonic vibration.

### BACKGROUND

When performing an ultrasonic examination, an operator can dispose an ultrasonic probe at any position on a scan target, orient the probe in any direction, perform imaging, and obtain a non-destructive/non-invasive ultrasonic image.

Such an ultrasonic probe may include a piezoelectric transducer including a piezoelectric material such as PZT (lead zirconate titanate: Pb(Zr, Ti)) a base block disposed on a side opposite to an ultrasonic wave irradiation side with respect to the piezoelectric transducer, a flexible printed circuit board (FPC) interposed between the base block and the piezoelectric transducer and connected to an electrode of the piezoelectric transducer, and a reflection layer disposed between the piezoelectric transducer and the FPC. In certain ultrasonic probes, the piezoelectric transducer layer and the reflective layer are embodied as a laminate formed on the FPC. A combination of the laminate including the transducer and the FPC may be referred to as a transducer element. The transducer element is disposed on the base block, and the ultrasonic probe is assembled. In this assembly, the transducer element is conventionally attached to the base block using an adhesive.

Conversely, the tip of the ultrasonic probe that directly or indirectly contacts the object to be inspected must have various shapes according to the properties of the object to be inspected. For example, there is a case where it is desired to observe an internal portion having a larger width at a deep portion with a wide angle with respect to a certain contact area as in an abdominal ultrasonic echo examination. A fan-shaped divergent ultrasound wave enables such observations. In order to enable the ultrasonic probe to send out an ultrasonic wave that diverges in a fan shape, the tip of the ultrasonic probe must have a curved surface. In addition, particularly when the object to be inspected is a human body or an animal, it is required that the contact of the tip of the ultrasonic probe not cause pain or discomfort to the object to be inspected or that the pain or discomfort is reduced. Even when the object to be inspected is not an organism, the tip of the ultrasonic probe may be designed to have a curved surface in order to reduce damage to the object to be inspected due to the inspection. In order to make the tip of the ultrasonic probe curved, the base block must also be curved in a shape corresponding thereto.

The transducer element disposed on the base block may not have sufficient flexibility, and it is not necessarily easy to bend the transducer element along the surface of a base block configured with a curved surface. Even when the transducer element is bent along the surface of the base block, deflection or the like occurs at an undesired position, and an undesired gap may be formed between the surface of the base block and the FPC. Furthermore, when a strong stress is applied to the transducer element in order to arrange the transducer element along the surface of the base block, the wiring of the FPC may be disconnected.

Each layer of the laminate included in the transducer element has its own role, and thus it is not easy to change the material of each layer of the laminate to a material having high flexibility from the viewpoint of maintaining the performance of the ultrasonic probe.

Therefore, a new technique is required which enables the transducer element to be bent into a desired shape while maintaining a performance as a transducer element.

### SUMMARY

A first aspect of the present disclosure provides an ultrasonic probe transducer element. The transducer element is disposed on a base block including a first portion having a first curvature and a second portion having a second curvature with a radius shorter than the first curvature. The transducer element includes a flexible printed circuit (FPC) disposed across the first portion and the second portion and a laminate including a transducer disposed on the FPC. The laminate including the transducer includes a layer of a piezoelectric element, wherein the laminate including the transducer includes a relatively shallow groove that does not completely cut the layer of the piezoelectric element and a relatively deep groove that completely cuts the layer of the piezoelectric element, the relatively shallow groove and the relatively deep groove are alternately disposed at a position corresponding to the first portion, and a plurality of the relatively deep grooves are contiguously disposed at a position corresponding to the second portion.

A second aspect of the present disclosure provides an ultrasonic probe module. The ultrasonic probe module includes the transducer element provided with the features of the first aspect of the present disclosure and the base block. The base block includes a sound absorbing material.

A third aspect of the present disclosure provides an ultrasonic probe. The ultrasonic probe includes the transducer element provided with the features of the first aspect of the present disclosure and the base block.

A fourth aspect of the present disclosure provides an ultrasonic diagnostic device. The ultrasonic diagnostic device includes an ultrasonic probe having the features of the third aspect of the present disclosure, an image processing unit that generates an ultrasonic image based on ultrasonic signals collected by the ultrasonic probe, and a display device that displays the ultrasonic image.

A fifth aspect of the present disclosure provides a method for producing an ultrasonic probe transducer element. The transducer element is disposed on a base block including a first portion having a first curvature and a second portion having a second curvature with a radius shorter than the first curvature. The production method includes a step for forming a laminate including a transducer on a flexible printed circuit board (FPC) to create a transducer element, the laminate including the transducer including a layer of piezoelectric elements and
a step for dicing the laminate including the transducer to form a plurality of grooves, the plurality of grooves including relatively shallow grooves that do not completely cut through the layer of piezoelectric elements and relatively deep grooves that completely cut through the layer of piezoelectric elements, the relatively shallow grooves and the relatively deep grooves being alternately disposed in a first portion of the transducer element, and the relatively deep grooves being contiguously disposed in a second portion of the transducer element.

A sixth aspect of the present disclosure provides a method for producing an ultrasonic probe module. The method for producing a module for an ultrasonic probe module includes a step for preparing the transducer element according to a method provided with the features of the fifth aspect of the present disclosure, a step for preparing the base block, and a step for disposing and bonding the transducer element on the base block such that the first portion of the transducer element is disposed on the first portion of the base block and the second portion of the transducer element is disposed on the second portion of the base block.

### BRIEF DESCRIPTION OF DRAWINGS

FIG. 1 A block diagram illustrating one example of a schematic configuration of an ultrasonic diagnostic system according to an embodiment.

FIG. 2 A diagram illustrating the external structure of the ultrasonic probe according to an embodiment.

FIG. 3 A diagram illustrating the external structure of the ultrasonic probe according to an embodiment.

FIG. 4 A cross-sectional view of a probe case bisected between front and rear according to an embodiment.

FIG. 5 A diagram illustrating the structure of a portion including a transducer element and a base block, corresponding to the upper left portion of FIG. 4 according to an embodiment.

FIG. 6 A diagram illustrating the structure of a portion including a conventional transducer element and base block, corresponding to the upper left portion of FIG. 4 according to an embodiment.

FIG. 7 A diagram illustrating the structure of a portion including a conventional transducer element and base block, corresponding to the upper left portion of FIG. 4 according to an embodiment.

FIG. 8A A diagram describing dicing that has been performed conventionally according to an embodiment.

FIG. 8B A diagram describing dicing performed according to the present invention according to an embodiment.

FIG. 9A A diagram illustrating the front surface of the FPC according to an embodiment.

FIG. 9B A diagram illustrating the back surface of the FPC according to an embodiment.

FIG. 9C A diagram illustrating the back surface of the FPC including the boundary between an active element and a dummy element according to an embodiment.

FIG. 10 A flowchart illustrating steps for producing the transducer element and the ultrasonic probe according to an embodiment.

FIG. 11 An exploded perspective view illustrating the internal structure of the ultrasonic probe according to an embodiment.

### DETAILED DESCRIPTION

Embodiments of the present invention will be described below. Note that the invention claimed in the embodiments described herein is not limited. In particular, in the present disclosure, a medical ultrasonic diagnostic system is described as an example. However, the present invention may be applied to an ultrasonic examination system, an ultrasonic examination device, and an ultrasonic probe for the non-destructive examination of buildings, structures, various mechanical devices, and the like.

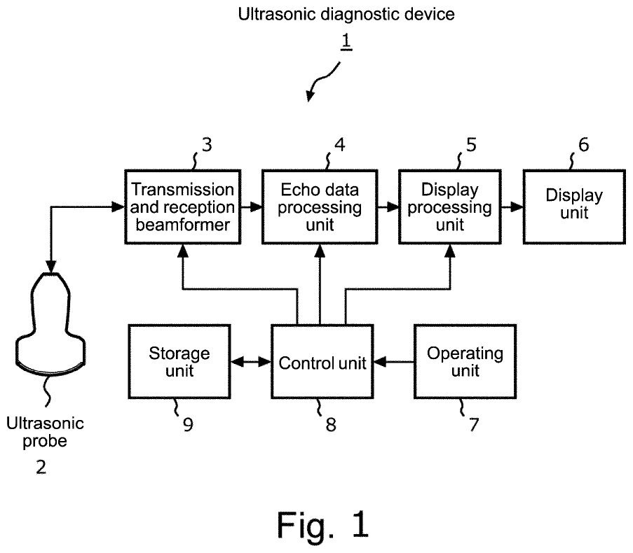

Embodiments of the present invention will be described hereinafter with reference to the drawings. The ultrasonic diagnostic device 1 illustrated in FIG. 1 is provided with an ultrasonic probe 2, a transmission and reception beamformer (beam former) 3, an echo data (echo data) processing unit 4, a display processing unit 5, a display unit 6, an operating unit 7, a control unit 8, and a storage unit 9. The ultrasonic diagnostic device 1 has a configuration as a computer (computer).

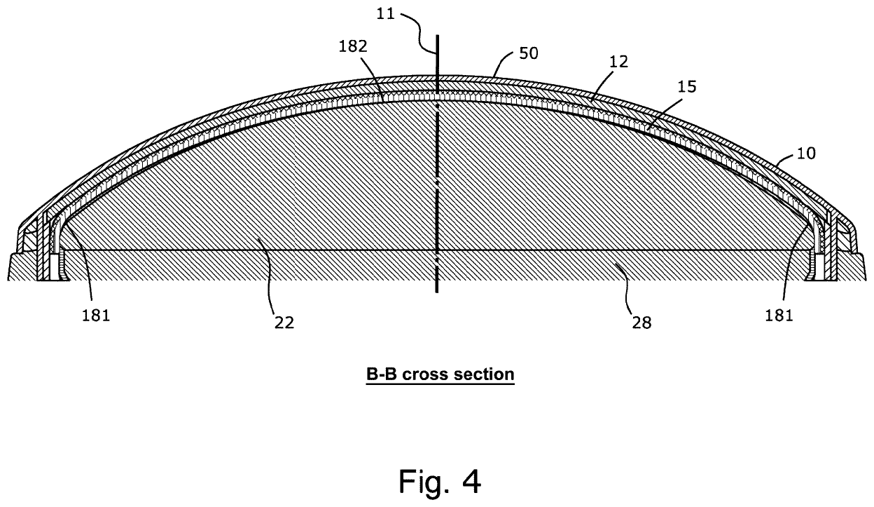

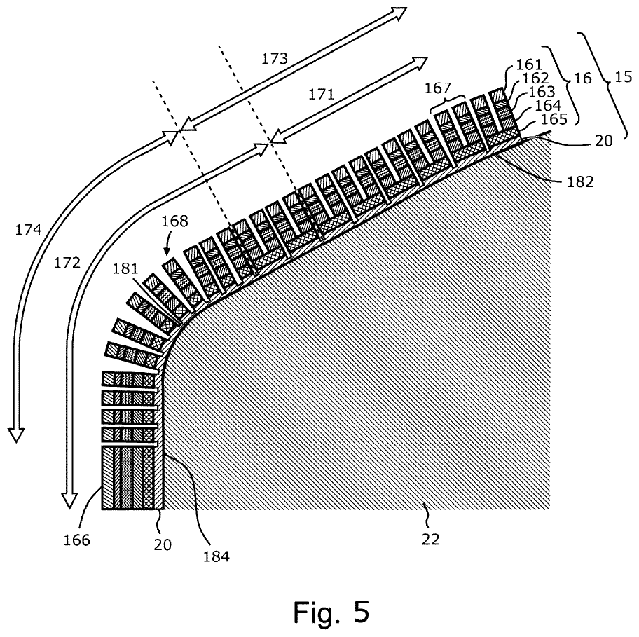

The ultrasonic probe 2 includes a plurality of ultrasonic transducers (see FIG. 4 and FIG. 5) disposed in an array, transmits ultrasonic waves to an examination target by the ultrasonic transducers, and receives an echo signal thereof.

The ultrasonic probe 2 transmits and receives ultrasonic waves to and from an examination target. The transmission and reception beamformer 3 supplies an electric signal for transmitting an ultrasonic wave from the ultrasonic probe 2 under a predetermined scanning condition to the ultrasonic probe 2 on the basis of a control signal from the control unit 8. Furthermore, the transmission and reception beamformer 3 performs signal processing such as A/D conversion and delay-and-sum processing on the echo signal received by the ultrasonic probe 2, and outputs the signal-processed echo data to the echo data processing unit 4.

The echo data processing unit 4 processes the echo data output from the transmission and reception beamformer 3 to create an ultrasonic image. For example, echo data processing unit 4 creates B-mode data by performing B-mode processing such as logarithmic compression processing or envelope detection processing.

The display processing unit 5 scan-converts data input from the echo data processing unit 4 using a scan converter (scan converter) to create ultrasonic image data. For example, the display processing unit 5 scan-converts B-mode data to create B-mode image data and causes the display unit 6 to display an ultrasonic image on the basis of the ultrasonic image data. The ultrasonic image is, for example, a B-mode image on the basis of the B-mode image data.

The display unit 6 is a liquid crystal display (LCD), an organic electro-luminescence (EL) display, or the like. The operating unit 7 is a device to which a user inputs instructions and information. For example, although not particularly illustrated in the drawings, the operating unit 7 includes a keyboard (keyboard) and also includes a pointing device (pointing device) such as a mouse (mouse), a trackball (trackball), or the like.

The control unit 8 is, for example, a processor such as a CPU (Central Processing Unit). The control unit 8 reads a program stored in the storage unit 9 and controls each unit of the ultrasonic diagnostic device 1. For example, the control unit 8 reads a program stored in the storage unit 9 and causes the read program to execute the functions of the transmission and reception beamformer 3, the echo data processing unit 4, and the display processing unit 5.

The control unit 8 may execute all of the functions of the transmission and reception beamformer 3, all of the functions of the echo data processing unit 4, and all of the functions of the display processing unit 5 by a program, or may execute only a part of the functions by a program. When the control unit 8 executes only a part of the functions, the remaining functions may be executed by hardware such as a circuit. Note that the functions of the transmission and reception beamformer 3, the echo data processing unit 4, and the display processing unit 5 may be implemented by hardware such as a circuit.

The storage unit 9 is a semiconductor memory (Memory) such an HDD (Hard Disk Drive: hard disk drive (HDD), an SSD (Solid State Drive), RAM (Random Access Memory), ROM (Read Only Memory), or the like.

The ultrasonic diagnostic device 1 may include all of the HDD, SSD, RAM, and ROM as the storage unit 9. Furthermore, the storage unit 9 may be a portable storage medium such as a CD (Compact Disk) or a DVD (Digital Versatile Disk). A program executed by the control unit 8 is stored in a non-transient storage medium such as an HDD or a ROM. Furthermore, the program may be stored in a portable non-transient storage medium such as a CD or a DVD.

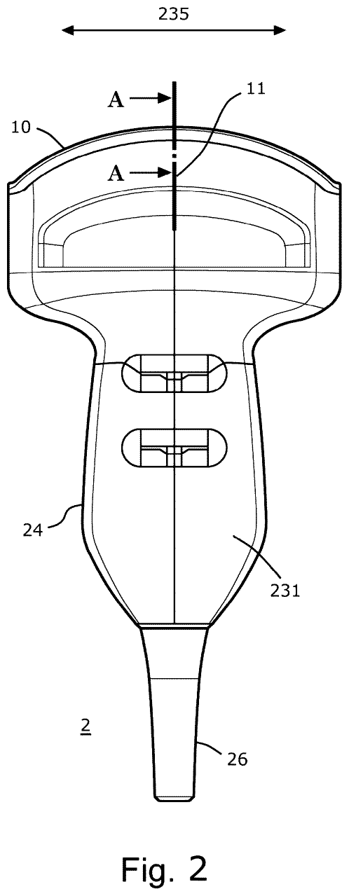

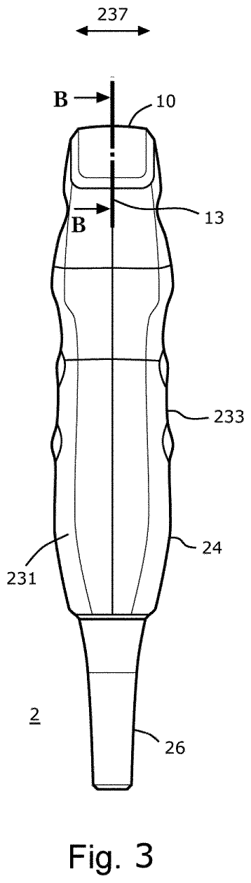

FIGS. 2 and 3 are diagrams illustrating the external structure of the ultrasonic probe 2. FIG. 2 is a front view of the ultrasonic probe 2, and FIG. 3 illustrates the right side surface of the ultrasonic probe 2. In the present embodiment, the ultrasonic probe 2 is a convex type ultrasonic probe, but may be another type of ultrasonic probe having an acoustic window with a convex curved surface, such as an ultrasonic probe for a bronchoscope or a transesophageal ultrasonic probe. A convex type ultrasonic probe has an acoustic window 10 with a convex curved surface, and radiates ultrasonic waves that diverge radially. Convex type ultrasonic probes are used for abdominal ultrasonic examinations, and the like.

As illustrated in FIGS. 2 and 3, the acoustic window 10 is bonded to the probe case 24 at the tip of the ultrasonic probe 2. In this example, a cable 26 is joined to the probe case 24 at the rear end of the ultrasonic probe 2. FIG. 2 illustrates the probe 2 placed such that the bottom surface 233 (see FIG. 3) is in contact with a supporting surface of the ultrasonic probe 2, such as a desk, table, or the like, so the surface of the probe 2 closer to the user is described as the upper surface 231 and the opposite surface is described as the bottom surface 233. However, in some embodiments, the upper surface 231 and the bottom surface 233 of the probe 2 may be identical in structure. In this case, when the probe 2 is placed upside down, the upper surface 231 of the probe 2 can be referred to as the bottom surface 233, and the bottom surface 233 of the probe 2 can be referred to as the upper surface 231. In consideration, the upper surface 231 and the bottom surface 233 of the probe 2 illustrated in FIGS. 2 and 3 can also be seen as the side surfaces of the probe 2, but to facilitate understanding by the reader, these two surfaces will be described as the upper surface 231 and the bottom surface 233 of the probe 2.

FIG. 4 is a cross-sectional view of an ultrasonic probe 2 according to some embodiments of the present invention, taken along a cross section 13 (see FIG. 3) that bisects the tip of the probe case 24 in which the acoustic window 10 is disposed between front and rear, and FIG. 5 is an enlarged view of a portion of the cross-sectional view. A cross-sectional view taken along a cross section 11 (see FIG. 2) that bisects the end of the probe case 24 between left and right does not differ greatly from that of the conventional ultrasonic probe 2 and thus is omitted.

As illustrated in FIG. 4, the acoustic window 10 in some embodiments of the present invention is positioned so as to cover an acoustic lens 12 and the module 28 containing the piezoelectric element 164. The module 28 including the transducer includes the transducer element 15 and the base block 22. A surface 50 of the acoustic window 10 has a shape suitable for contacting the object to be imaged. As illustrated in FIG. 5, the transducer element 15 includes a flexible printed wiring board (FPC) 20 and a laminate 16 laminated on the FPC 20. In the example of FIG. 5, the laminate 16 including the transducer includes a second acoustic matching layer 161, a ground electrode 162, a first acoustic matching layer 163, a piezoelectric element 164, and a reflection layer 165. The transducer is configured from at least the piezoelectric element 164. As is apparent to those skilled in the art, the types and order of layers included in the laminate 16 including the transducer are different depending on the manufacturer and the type of examination target. The types and order of the layers illustrated in FIG. 4 are merely examples, and the present invention can be applied to a laminate or a transducer element other than the specific laminate 16 or the specific transducer element 15 illustrated here.

The piezoelectric element 164 converts an electrical signal into vibration to generate ultrasonic waves, and vibrates upon receiving an echo signal, which is then converted into an electrical signal. The piezoelectric element 164 can be formed from a known material such as PZT ceramic. The second acoustic matching layer 161 the first acoustic matching layer 163 having a multi-layer structure is provided on the piezoelectric element 164 in order to acoustically match the acoustic impedance of the piezoelectric element 164 to the acoustic impedance of the target. The second acoustic matching layer 161 may be formed from a known material such as a cross-linked polystyrene resin (REXOLITE: registered trademark). The first acoustic matching layer 163 may be formed from a known material such as graphite. The ground electrode 162 is an electrode for grounding.

The acoustic lens 12 is provided on the upper surface of the second acoustic matching layer 161 to allow the ultrasonic waves to efficiently converge on the target, and so that the ultrasonic waves will be transmitted and received through the acoustic lens 12. In some embodiments of the present invention, protecting the acoustic lens 12 with an acoustic window 10 allows the acoustic lens 12 to be made of a soft, delicate material that has good acoustic properties, and allows the selection of a material suitable for propagation and refraction of ultrasonic waves. One specific material that can be used for the acoustic lens 12 is silicone rubber, which has an acoustic impedance close to that of water and has excellent moldability and releasability.

The convex surface of the acoustic window 10 that contacts the target can have a uniform thickness in the azimuth direction. Thereby the acoustic window 10 can be easily produced with the shape and dimensions as designed, reducing the possibility of producing defective products that do not meet the design specifications and improving yields. The acoustic lens 12 has a convex outer surface that corresponds to the concave shape of the rear surface of the acoustic window 10, and the convex outer surface of the acoustic lens 12 is acoustically coupled to the rear surface of the acoustic window 10. In some embodiments, this acoustic coupling is accomplished using an adhesive.

The ultrasonic waves generated by the piezoelectric element 164 travel not only forward but also rearward. A reflective layer 165 is provided to reflect ultrasonic waves traveling rearward, and a base block 22 formed from a sound absorbing material is provided to absorb ultrasonic waves traveling rearward, thus suppressing unnecessary vibrations. The ultrasonic waves have a property of being reflected by an object having a high hardness. Thus, the reflective layer 165 may be formed from a metal such as tungsten, particularly, tungsten carbide having high hardness. As will be appreciated by those skilled in the art, tungsten carbide is an alloy of tungsten and carbon. Tungsten carbide is known as a hard material second to diamond. In addition to its high hardness, tungsten carbide is also excellent in wear resistance, corrosion resistance, impact resistance, and durability.

The FPC 20 serves as a lead wire, transmitting electrical signals from electronic components (not illustrated) to the piezoelectric element 164 and transmitting electrical signals from the piezoelectric element 164 to the electronic components (not illustrated). Furthermore, the electric power from the cable 26 is also transmitted to the laminate 16 including the transducer via the FPC 20.

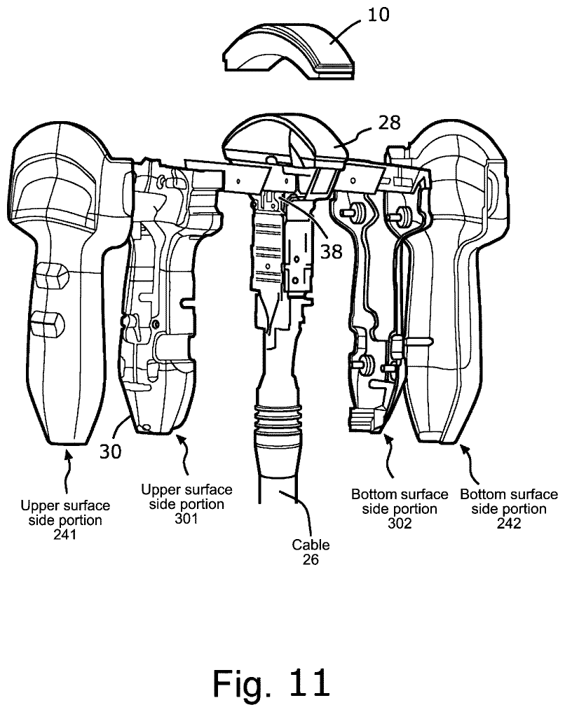

In some embodiments, the acoustic lens 12 is a portion of a module 28 that includes a transducer, and in some embodiments, the acoustic lens 12 is coupled to the module 28 that includes an ultrasonic transducer (FIG. 11) using an adhesive such that the convex outer surface of the acoustic lens 12 is acoustically coupled to the rear surface of the acoustic window 10. The convex outer surface of the acoustic lens 12 and the rear surface of the acoustic window 10 are also bonded using an adhesive. The adhesive may be a silicone-based adhesive or an epoxy resin-based adhesive. The same applies to the adhesive used for other constituent elements.

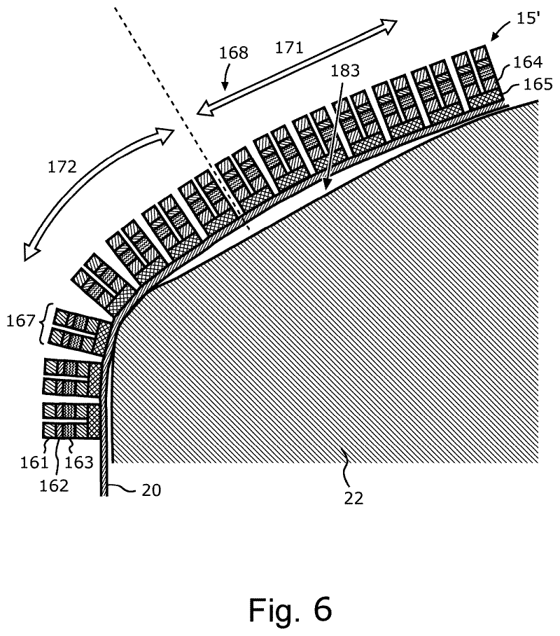

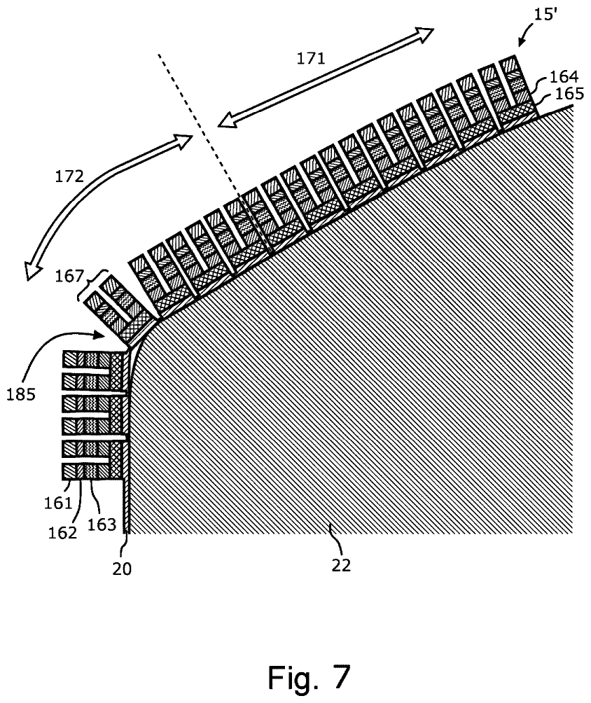

The transducer element 15 according to one embodiment of the present invention illustrated in FIG. 5 and the conventional transducer element 15′ illustrated in FIGS. 6 and 7 will be described. Right ends of the transducer elements 15 and 15′ are illustrated as if they were cut on the base block 22. However, this has been done for ease of understanding by the reader, and in practice, as illustrated in FIG. 4, the transducer elements 15 of FIG. 5 are disposed across the base block 22 in an azimuth direction 235. In a particular embodiment, the arrangement of the transducer elements 15 is symmetrical with respect to the cross section 11. In FIGS. 5 to 7, the acoustic window 10 and the acoustic lens 12 illustrated in FIG. 4 have been removed to facilitate a more detailed view of the transducer elements 15 and 15′.

FIG. 5 is an enlarged view of a portion of FIG. 4. As illustrated in FIGS. 4 and 5, the transducer element 15 is preferably bonded to the base block 22 in close contact therewith in the azimuth direction 235. However, depending on the shape of the base block 22 on which the transducer element 15 is disposed, it is not easy to bond the transducer element 15 in close contact with the base block 22 across the azimuth direction 235. In the embodiment of FIGS. 4 and 5, the base block 22 has shoulders 181 at both ends in the azimuth direction 235, and a central portion 182 is disposed at a position sandwiched between the shoulders 181 at both ends. The active element is disposed in a section indicated by a double-headed arrow 171, and the dummy element is disposed in a section indicated by a double-headed arrow 172. The elements included in the active element transmit the ultrasonic signal and receive the echo signal. Conversely, the element included in the dummy element does not transmit the ultrasonic signal and does not receive the echo signal. A dummy element is disposed on the shoulder 181. In some embodiments, a radius of curvature R1 of the central portion 182 of the base block 22 is between 45 cm and 65 cm. The radius of curvature R1 is more preferably from 50 cm to 60 cm. Even more preferably, the radius of curvature R1 is 54.096±0.05 cm. In addition, a radius of curvature R2 of the shoulder 181 of the base block 22 is 2.5 cm to 3.5 cm. The radius of curvature R2 is more preferably 2.0 cm to 3.0 cm. Even more preferably, the radius of curvature R2 is 2.5 cm. By appropriately setting the curvature radii R1 and R2, the ultrasonic probe 2 can send out ultrasonic waves that diverge in an ideal fan shape, and contact with the examination target is improved.

However, due to reasons such as the transducer element 15 having the reflection layer 165 having high hardness, it is not easy to bond the conventional transducer element 15′ to the base block 22 having such an ideal shape without a gap. The radius R1 of curvature of the central portion 182 of the base block 22 is sufficiently long to allow the conventional transducer element 15′ to be bent relatively easily to that radius of curvature, but the radius R2 of curvature of the shoulder 181 of the base block 22 is not sufficiently long to allow the transducer element 15′ to be bent relatively easily to that radius of curvature. Therefore, as illustrated in FIG. 6, the conventional transducer element 15′ cannot be maintained in a state of being sufficiently bent to the length of the radius of curvature R2, and the adhesive between the conventional transducer element 15′ and the base block 22 may peel off, resulting in a gap 183. In some cases, the gap 183 may be generated by the destruction of the FPC 20. Furthermore, when the transducer element 15′ cannot be bent to the length of the radius of curvature R2, the process may not proceed to the bonding step using the adhesive.

As illustrated in FIG. 6, when the gap 183 occurs between the conventional transducer element 15′ and the base block 22, the result is that it is not possible to pass a Time of Flight inspection (hereinafter referred to as “TOF inspection”), which is one of the inspection items of the acoustic inspection. In the TOF inspection, a target is put in a water tank, an ultrasonic wave is emitted, and an echo signal from the target is received, thereby measuring a distance for each channel and obtaining a measurement error. When the conventional transducer element 15′ is lifted from the base block 22 due to an occurrence of a deflection, the distance to the target changes, and the distance differs from the designed distance, resulting in a large error. Furthermore, when the transducer element 15′ is lifted from the base block 22 due to the deflection, the sound absorption by the base block 22 is not sufficiently performed, and the noise increases. Moreover, when the transducer element 15′ is lifted from the base block 22 due to the deflection, the transducer element 15′ itself vibrates, and noise occurs.

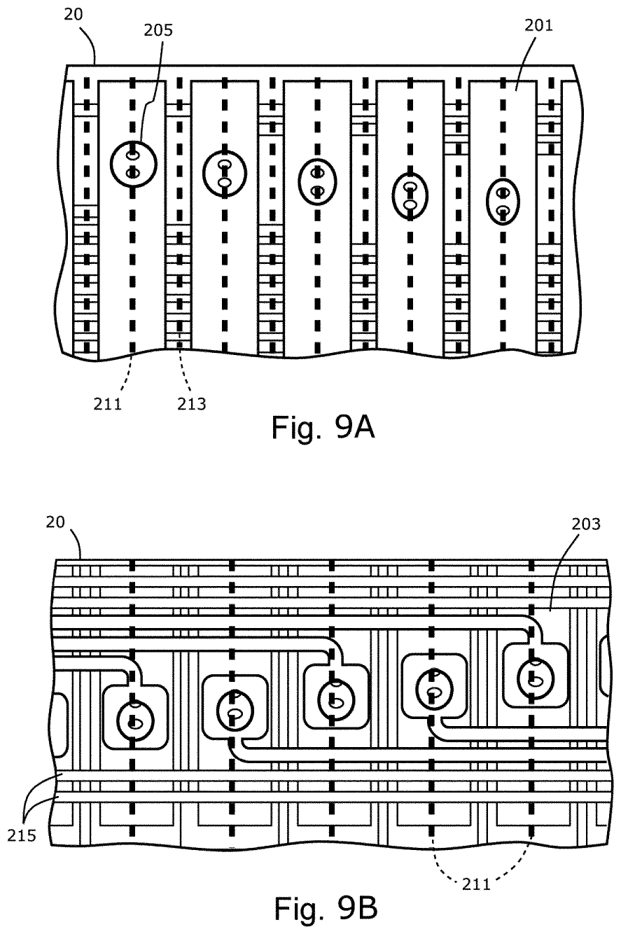

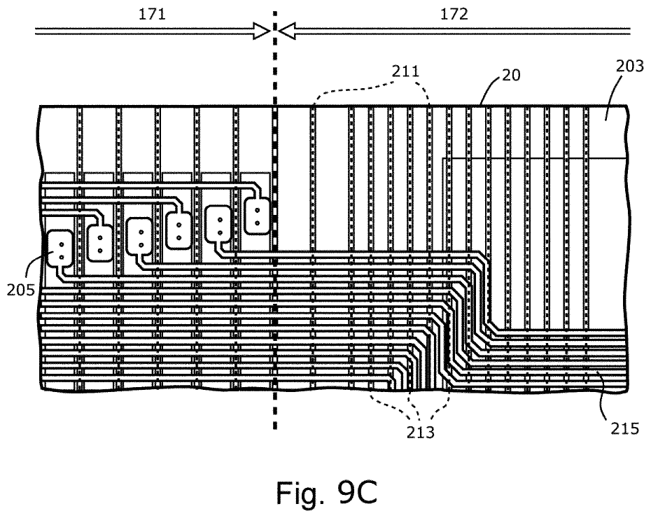

Conversely, when a large force is applied to the conventional transducer element 15′ so as to conform to the radius of curvature R2 of the base block 22, as illustrated in FIG. 7, a location 185 where the elements of the laminate 16 are largely separated from each other occurs. When the elements of the laminate 16 are greatly separated from each other, great stress with the reflective layer as a fulcrum is applied to the FPC 20 portion which is a point of action, according to the principles of leverage. This great stress may break the wiring 215 (see FIG. 9) in the FPC 20. That is, a portion where the elements of the laminate 16 are largely separated from each other may be the disconnection location 185. In some embodiments, the FPC 20 wiring 215 extends in the azimuth direction 235, and the elements located in the central portion 182 of the transducer elements 15′ are also connected to the electronic components (not illustrated) in the ultrasonic probe 2 and power lines from the cable 26 (FIG. 2) via the wiring 215 that passes over the shoulder 181. Therefore, when the disconnection location 185 occurs, the transmission and reception of signals between the element located in the central portion 182 and the electronic component in the ultrasonic probe 2 cannot be performed, or power cannot be received.

Even when no disconnection occurs, when the location 185 where adjacent elements of the laminate 16 are largely separated from each other occurs as illustrated in FIG. 7, the outer shape of the transducer element 15′ may be largely deviated from the outer shape of the transducer element 15′ as originally designed, and may not conform to the shape of the inner surface of the acoustic window 10. When the outer shape of the transducer element 15′ does not match the shape of the inner surface of the acoustic window 10, the assembly of the ultrasonic probe 2 cannot be performed as a result.

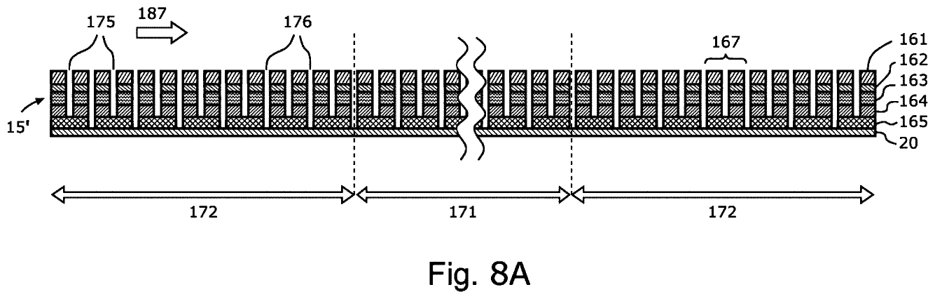

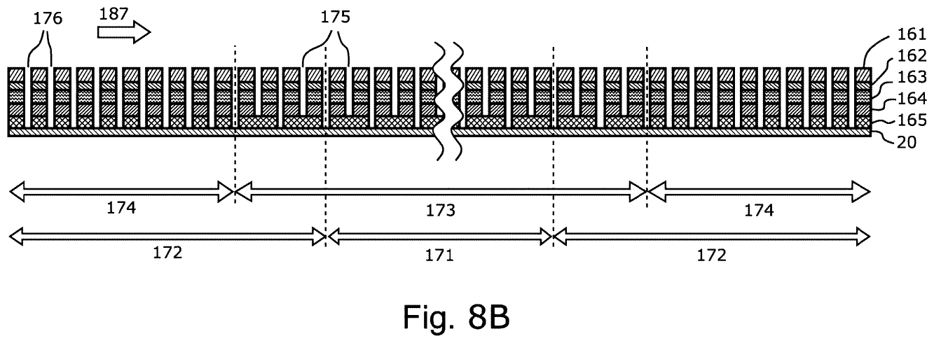

In order to avoid the problems described with reference to FIGS. 6 and 7 and to dispose the transducer elements 15 on the base block 22 in the manner illustrated in FIG. 5, the conventional dicing illustrated in FIG. 8A is changed to the dicing illustrated in FIG. 8B.

FIG. 8A is a diagram describing dicing that has been performed conventionally. As illustrated in the drawing, in conventional art, relatively shallow grooves 175 and relatively deep grooves 176 are alternately formed in a dicing direction 187 without distinguishing between a section 171 in which active elements are disposed and a section 172 in which dummy elements are disposed. The section 171 in which the active elements are disposed is longer than the section 172 in which the dummy elements are disposed, and thus most of the section 171 in which the active elements are disposed is omitted in the drawing. In some embodiments, the relatively shallow grooves 175 are grooves that are deep enough to reach the piezoelectric element 164. More specifically, the relatively shallow grooves 175 are formed by dicing 50 to 98% of the thickness of the piezoelectric element 164. More preferably, this range is 70 to 95% of the thickness of the piezoelectric element 164, and even more preferably 75 to 90%. In some embodiments, the relatively deep grooves 176 have the reflective layer 165 completely cut (that is, the laminate 16 is completely cut) and has a depth reaching the FPC 20. More particularly, the relatively deep grooves 176 are formed by dicing 0 to 60% of the thickness of the FPC 20. More preferably, this range is from 15 to 40% of the thickness of the FPC 20, even more preferably from 33 to 35%. When the relatively deep groove 176 is formed deeper, there is an advantage that the transducer element 15 is easily bent, but there is a high possibility that the FPC 20 is damaged by dicing or the attachment process of the transducer element 15. In the section 171 in which the active elements are disposed, a portion sandwiched between two contiguous relatively deep grooves 176 forms one channel. In the present Specification, in the section 171 in which the active elements are disposed, a portion which is sandwiched between two contiguous relatively deep grooves 176 and has one relatively shallow groove 176 to form one channel is referred to as a U-shaped element 167 having a shallow groove.

FIG. 8B is a diagram describing dicing performed according to the present invention. As illustrated in the drawing, in the section 171 in which the active elements are disposed, relatively shallow grooves 175 and relatively deep grooves 176 are alternately formed as in the conventional case. In some embodiments, the relatively shallow grooves 175 are formed by scraping the piezoelectric elements 164 to a depth that leaves 0.005 mm to 1 mm, more preferably 0.01 mm to 0.05 mm, and even more preferably 0.02 mm. In addition, the relatively deep grooves 176 are formed by scraping the FPC 20 by 0.1 mm to 0.020 mm, more preferably 0.03 mm to 0.04 mm, and still more preferably 0.035 mm. In some embodiments, the widths of the relatively shallow grooves 175 and the relatively deep grooves 176 may both be set to 0.01 mm to 0.1 mm, more preferably 0.03 mm to 0.05 mm, and even more preferably 0.04 mm. In other embodiments, the width of the relatively shallow grooves 175 and the width of the relatively deep grooves 176 are set such that one is narrower than the other. In the section 173 having the shallow and deep repeating grooves, both the distances between adjacent relatively deep grooves 176 and the distances between adjacent relatively shallow grooves 175 may both be set to 0.2 mm to 0.5 mm, more preferably 0.3 mm=0.4 mm, and even more preferably 0.35 mm. The section 173 having the shallow and deep repeating grooves may be extended to the section 172 in which the dummy elements are disposed. In other words, the section 174 having the deep continuous grooves may be designed to be shorter than the section 172 in which the dummy elements are disposed. In the example of FIG. 8B, two U-shaped elements 167 having shallow grooves are disposed outside the section 171 in which the active elements are disposed. The number of U-shaped elements 167 having shallow grooves disposed in the section 172 in which the dummy elements are disposed may be 0 to 5, more preferably 1 to 3, and more preferably 2. By disposing the U-shaped element 167 having a shallow groove in the section 172 in which the dummy elements are disposed, there is an advantage in that the deepest position of all the relatively deep grooves 176 can be visually confirmed even when the deepest position of the groove is obstructed from being visually recognized due to the presence of the ground electrode 162. Furthermore, by disposing the U-shaped element 167 having a shallow groove in the section 172 in which the dummy elements are disposed, it is possible to reduce the possibility that the relatively shallow groove 175 of the U-shaped element 167 having a shallow groove disposed at both ends of the section 171 in which the active elements are disposed is formed deeper than the designed depth. As illustrated in FIG. 8B, in the section 173 having the shallow and deep repeating grooves, relatively shallow grooves 175 and relatively deep grooves 176 are alternately formed. In a section 174 having deep continuous grooves, the relatively deep grooves 176 are formed contiguously. In this specification, in the section 174 having deep continuous grooves, a portion sandwiched between two continuous relatively deep grooves 176 is referred to as an I-shaped element 168. In this example, the section 174 having deep continuous grooves is disposed at both ends of the transducer element 15. However, as illustrated in FIG. 5, a dummy element 166 having a large width and having no groove formed therein may be disposed at both ends or one end of the transducer element 15. By placing a large width dummy element 166, which is not grooved, at the end of the transducer element 15, several advantages can be obtained. For example, by reducing the number of times of dicing of the transducer element 15, the transducer element 15 can be formed quickly and inexpensively. In addition, even when the quality of the laminate 16 is not necessarily high and some layers do not reach the end portion and are disconnected, the element does not collapse due to dicing. The wide dummy element 166, which is not grooved, also improves the robustness of the transducer element 15. The portion where the relatively deep grooves 176 are contiguously formed tends to have a reduced robustness due to the grooves, but the dummy element 166 having a large width in which no groove is formed serves to protect the portion where the relatively deep grooves 176 are contiguously formed. The width of the dummy element 166 having a large width in which no groove is formed may be 0.7 to 5.5 times, more preferably 1.5 to 4.5 times, and more preferably 2.5 to 3.5 times the width of the U-shaped element 167 having a shallow groove. In another embodiment, the section 174 having the deep continuous grooves may be disposed in the center of the section 172 in which the dummy elements are disposed, and the sections 173 having the shallow and deep repeating grooves may be disposed at both ends of the section 172 in which the dummy elements are disposed. In either case, dicing is performed so that the I-shaped elements 168 of the section 174 having the deep continuous grooves are disposed on the shoulder 181 of the base block 22. The section 174 having the deep continuous grooves may be 50 to 95%, more preferably 70 to 90% of the section 172 in which the dummy elements are disposed. The relatively shallow grooves 175 and the relatively deep grooves 176 are formed by cutting the piezoelectric element 164 across the entire width of the piezoelectric element 164 in an elevation direction.

In the example of FIG. 8B, the pitch of dicing in the section 174 having the deep continuous grooves is the same as the pitch of dicing in the section 173 having the shallow and deep repeating grooves. In this embodiment, the present invention can be implemented without greatly changing the conventional dicing control program, and yield is also improved. In another embodiment, the pitch of dicing in the section 174 having the deep continuous grooves is set to be different from the pitch of dicing in the section 173 having the shallow and deep repeating grooves. Specifically, the dicing pitch in the section 174 having the deep continuous grooves is set to be 50 to 90% of the dicing pitch in the section 173 having the shallow and deep repeating grooves. As the dicing pitch in the section 174 having deep continuous grooves is reduced, the flexibility is increased, resulting in easier bending. Conversely, as the dicing pitch in the section 174 having the deep continuous grooves becomes shorter, the possibility of the element being broken during dicing increases.

FIG. 9A is a diagram illustrating the front surface 201 of the FPC 20, and FIG. 9B is a diagram illustrating the rear surface 203 of the FPC 20. In a preferred embodiment of the present invention, the relatively shallow grooves 175 in the section 171 where the active elements are disposed are formed at positions corresponding to dashed lines 211. The dashed lines 211 pass through vias 205 provided on the front surface 201 the FPC 20. As described above, the relatively shallow groove 175 is a groove having a depth reaching the piezoelectric element 164, and does not reach a reflective layer 165. Therefore, the relatively shallow grooves 175 do not affect the electrical connection through the vias 205 between the conductive reflective layer 165 and the wiring 215 (FIG. 9B) provided on the rear surface 203 of the FPC 20. The relatively deep grooves 176 in the section 171 in which the active elements are disposed are formed at positions corresponding to dashed lines 213. The vias 205 are not present at positions corresponding to the dashed lines 213 (FIG. 9C), the relatively deep grooves 176 do not affect the electrical connection between the reflective layer 165 and the wiring 215 provided on the rear surface 203 of the FPC 20 through the vias 205. In the example of FIG. 9B, the wiring 215 extends in the azimuth direction 235 on the rear surface 203 of the FPC 20 for easy understanding of the reader, but the FPC 20 may have a plurality of layers and the wiring 215 may be provided in an intermediate layer.

The relatively deep grooves 176 in the section 174 having deep continuous grooves are formed at positions corresponding to the dashed lines 211 and the dashed lines 213. It is meaningless to dispose the vias 205 in the section 172 in which the dummy elements are disposed. In the preferred embodiment of the present invention, as illustrated in FIG. 9C, the vias 205 are not disposed in the section 172 in which the dummy elements are disposed. The section 174 having the deep continuous grooves is provided only in the section 172 in which the dummy elements are disposed, and thus the problem that the relatively deep groove 176 breaks the electrical connection through the vias 205 between the reflective layer 165 and the wiring 215 provided on the rear surface 203 of the FPC 20 would not occur.

Returning to FIG. 5, the description is continued. As illustrated in the drawing, the transducer element 15 is bonded along the surface of the base block 22 so that the gap 183 in FIG. 6 and the disconnection location 185 in FIG. 7 do not occur. The base block 22 includes a pair of shoulders 181 near both ends thereof, and the section 174 having the deep continuous grooves is positioned in the pair of shoulders 181, whereby the transducer element 15 is brought into close contact with the shoulders 181. The section 174 having the deep continuous grooves is more flexible and bendable than the section 173 having the shallow and deep repeating grooves because the relatively deep grooves 176 are contiguous. In particular, in embodiments where the relatively shallow grooves 175 do not cut through the reflective layer 165 and the relatively deep grooves 176 cut or ablate substantially the entirety or almost all of the reflective layer 165, the flexibility or bendability of the section 174 having the deep continuous grooves is dramatically improved. The improvement in flexibility and bendability allows the transducer element 15 (FPC 20) to be in close contact so as to follow the shoulder 181 having the short radius of curvature R2. More specifically, the rear surface 203 of the FPC 20 is fixed to the front surface of the base block 22 using an adhesive. As described above, the adhesive may be a silicone-based adhesive or an epoxy resin-based adhesive. Due to the close contact described above, both risk of failing the TOF inspection and risk of causing disconnection can be avoided at the same time, the product quality is improved, and a more stable product can be provided. As illustrated, the section 173 having the shallow and deep repeating grooves is disposed in the central portion 182 between the pair of shoulders 181. The transducer element 15 extends beyond the shoulders 181. The FPC 20 of the transducer element 15 extends in the direction of the rear end of the ultrasonic probe 2 and is connected to electronic components that are not illustrated via connectors that are not illustrated. The position where the FPC 20 extends in the rear end direction may be only the left side of the page of FIG. 2, only the right side, or both the left and right sides.

Continuing to refer to FIG. 5, in the particular embodiment illustrated, the laminate 16 of transducer elements 15 is also disposed on the side portion 184 of the base block 22 beyond the shoulder 181. In another particular embodiment, the laminate 16 of transducer elements 15 is not disposed on the side portion 184 of the base block 22. When the laminate 16 is disposed on the side portion 184 of the base block 22, the portion of the laminate 16 disposed on the side portion 184 can serve as a barrier for the active element. For example, even when an event occurs in which an external impact is applied to the side portion 184 during the assembly process of the ultrasonic probe 2, the impact is absorbed by the portion of the laminate 16 disposed on the side portion 184, and the influence on the active element 171 is reduced to a level at which no problem occurs. It is also possible to dispose constituent elements for absorbing impact without disposing the laminate 16 on the side portion 184 of the base block 22, but in this case, there is a possibility that a problem of an increase in the number of production steps and an increase in cost may occur.

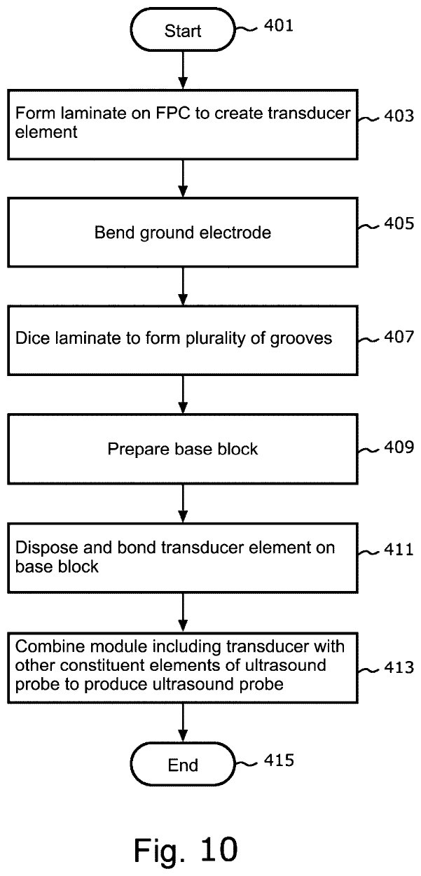

Next, steps for producing the transducer element and steps for producing the ultrasonic probe will be described with reference to FIG. 10. The process starts at step 401. In step 403, the laminate 16 is formed on the FPC 20 to create the transducer element 15. As described above, in a particular embodiment, the laminate 16 including the transducer includes a second acoustic matching layer 161, a ground electrode 162, a first acoustic matching layer 163, a piezoelectric element 164, and a reflection layer 165. The formation of the laminate 16 on the FPC 20 can be performed according to a known method, and therefore, detailed description thereof is omitted.

In step 405, the ground electrode 162 is folded. Before the ground electrode 162 is bent in step 405, the ground electrode 162 protrudes in the elevation direction 237 (into the page in FIGS. 4 to 8) at least in the section 171 in which the active elements are disposed. In certain embodiments, in the section 172 in which the dummy elements are disposed, the ground electrode 162 does not need to protrude in the elevation direction 237. This minimizes the material and reduces the weight and cost. However, by extending the portion of the ground electrode 162 protruding in the elevation direction 237 to the section 172 in which the dummy elements are disposed, it is possible to improve the possibility that the elements located at both ends of the section 172 in which the dummy elements are disposed reliably function. The extension of the ground electrode 162 described above may correspond to the number of U-shaped elements 167 having shallow grooves disposed in the section 172 in which the dummy elements are disposed. As described above, the types and order of layers included in the laminate 16 including the transducer are different depending on the manufacturer and the type of examination target, and step 405 may not be an essential step.

In step 407, the laminate 16 is diced to form a plurality of grooves. As described in FIG. 8B, in the section 173 having the shallow and deep repeating grooves, relatively shallow grooves 175 and relatively deep grooves 176 are alternately formed. In the section 174 having deep continuous grooves, the relatively deep grooves 176 are formed contiguously. When the ground electrode 162 is bent in step 405, the bent portion of the ground electrode 162 has a sufficient length and is not completely cut by the dicing process. The bent portion of the ground electrode 162, which is not completely cut, is connected to a ground.

In step 409, the base block 22 is provided. As described above, the base block 22 includes a first portion (central portion 182) having a first radius of curvature R1 and a second portion (the shoulder 181) having a second radius of curvature R2 that is shorter in radius than the first radius of curvature R1. The base block 22 may be configured from a sound absorbing material.

In step 411, the transducer element 15 is disposed and bonded on the base block 22. As described above, the section 174 having the deep continuous grooves of the transducer element 15 is positioned at the pair of shoulders 181 of the base block 22, thereby realizing close contact between the transducer element 15 and the base block 22. The base block 22 to which the transducer element 15 is attached may be a module 28 including a transducer.

In step 413, the ultrasound probe is produced according to a production process for combining with the constituent elements of the ultrasound probe 2, and the production process ends in step 415. In some embodiments, step 413 may be implemented by producing the ultrasound probe according to a conventional ultrasound probe production process. The module 28 including the transducer including the novel transducer element 15 produced according to the present invention can be handled in the subsequent production process in the same manner as the module 28 including the conventional transducer, and the production cost can be reduced.

FIG. 11 is an exploded perspective view depicting the internal structure of the ultrasonic probe. In the present embodiment, a metallic inner housing 30 is provided inside the probe case 24 of the ultrasonic probe 2. The inner housing 30 diffuses heat generated in the module 28 including the transducer, and prevents the heat generated in the module 28 including the transducer from being transmitted to the target. The outer surface of the inner housing 30 has a shape conforming to the inner surface of the probe case 24. The inner housing 30 may be produced by a known method such as casting, additive manufacturing, CNC processing, forging, or press working. An upper surface side portion 301 and a bottom surface side portion 302 of the inner housing 30 are bonded to each other by an adhesive. The inner surface of the probe case 24 is attached to the outer surface of the inner housing 30 by an adhesive. An upper surface side portion 241 and a bottom surface side portion 242 of the probe case 24 are also bonded to each other by an adhesive. The front end of the probe case 24 is adhered to the acoustic window 10, and the rear end of the probe case 24 is adhered to the cable 26.

A chassis 38 is positioned inside the inner housing 30. One or more electronic components (not illustrated) are provided inside the chassis 38. The chassis 38 can be fixed to the module 28 including the transducer by screws, such that the constituent elements fixed thereto are not easily removed or moved from the prescribed positions in the ultrasonic probe 2. The chassis 38 may also be secured to other constituent elements, such as the inner housing 30, using a variety of fastening means known in the art. In a particular embodiment of the present invention, electronic components (not illustrated) are removably connected to the cable 26 by a connector (not illustrated) and to the module 28 including the transducer by another connector (not illustrated). Thereby, power from the cable can be supplied to the electronic components (not depicted) or the module 28 including the transducer. Moreover, bidirectional signal transmission via the cable 26 is possible.

In some embodiments of the present invention, an acoustic lens 12 is attached to the rear surface of the acoustic window 10 as illustrated in FIG. 11. The module 28 including the transducer and the acoustic lens 12 are also bonded together to be acoustically bonded together. Next, the module 28 including the transducer and the chassis 38 are fixed with screws, and the electronic components of the module 28 including the transducer and the cables are connected using connectors. The position of the connector connection may be a position below or on the side of the module 28 including the transducer. The upper surface side portion 301 and the bottom surface side portion 302 of the inner housing 30 are joined to each other so as to enclose or sandwich the module 28 including the transducer. Next, the upper surface side portion 241 and the bottom surface side portion 242 of the probe case 24 are joined to each other so as to enclose or interpose these components. The inner surface of the probe case 24 near the tip end has a shape corresponding to the first wall portion. The inner surface of probe case 24 and the first wall portion are bonded using an adhesive.

The adhesive used for assembling the ultrasonic probe 2 is preferably an adhesive having excellent chemical resistance and ultraviolet ray resistance, such as a silicone adhesive, epoxy resin adhesive, and the like. In terms of miniaturization, it is preferable that the thickness of the adhesive is 5 mm or less. In terms of the strength of the adhesive, it is preferable that the thickness of the adhesive is 0.3 mm or greater. More preferably, the adhesive has a thickness of 1 to 4 mm. The adhesive applied to each part may be the same adhesive or different adhesives.

Further aspects of the present invention may be provided by the embodiments of the following provisions.

Provided is an ultrasonic probe transducer element disposed on a base block including a first portion having a first curvature and a second portion having a second curvature with a radius shorter than the first curvature. The transducer element includes a flexible printed circuit (FPC) disposed over the first portion and the second portion and a laminate including a transducer disposed on the FPC, wherein the laminate including the transducer includes a layer of piezoelectric elements, the laminate including the transducer includes relatively shallow grooves in which the layer of piezoelectric elements is not completely cut and relatively deep grooves in which the layer of piezoelectric elements is completely cut, the relatively shallow grooves and the relatively deep grooves are alternately disposed at positions corresponding to the first portion, and the plurality of relatively deep grooves are contiguously disposed at positions corresponding to the second portion.

Provided also is the transducer element according to the preceding embodiment, wherein the FPC includes wiring and vias connected to the wiring, the laminate including the transducer includes a reflective layer disposed between the layer of the piezoelectric element and the FPC, the reflective layer contains a metal and is conductive, the reflective layer is connected to the vias at a position corresponding to the first portion, and the relatively deep grooves cut through at least a portion of the reflective layer.

Provided also is the transducer element according to any preceding embodiment, wherein the metal of the reflective layer includes tungsten.

Provided also is the transducer element according to any preceding embodiment, wherein the wiring of the FPC extends in an azimuth direction.

Provided also is the transducer element according to any preceding embodiment, wherein the first portion and the second portion are disposed to be aligned in the azimuth direction.

Provided also is the transducer element according to any preceding embodiment, wherein the laminate including the transducer includes an acoustic matching layer disposed on a layer of piezoelectric elements.

Provided also is the transducer element according to any preceding embodiment, wherein the laminate including the transducer includes a ground electrode layer disposed on the layer of piezoelectric elements.

Provided also is the transducer element according to any preceding embodiment, wherein the relatively shallow grooves cut the piezoelectric element across the entire width of the piezoelectric element in an elevation direction, and the relatively deep grooves also cut the piezoelectric element across the full width of the piezoelectric element in the elevation direction.

Provided also is an ultrasonic probe module. The ultrasonic probe module includes the transducer element according to any preceding embodiment and the base block, and The base block includes a sound absorbing material. The module according to any preceding embodiment, wherein the base block includes a pair of shoulders, the first portion is disposed between the pair of shoulders, the second portion is disposed on one or both of the pair of shoulders, and the transducer element extends beyond either or both of the pair of shoulders.

According to an aspect, the module according to any preceding embodiment, wherein the FPC is bonded to the base block without a gap at least at a portion extending from one of the pair of shoulders to the other of the pair of shoulders.

Provided also is an ultrasonic probe having the transducer element according to any preceding embodiment and the base block.

According to an aspect, the ultrasonic probe according to any preceding embodiment, including an acoustic lens disposed on the transducer element, an acoustic window covering the module and the acoustic lens, and a probe case covering at least a lower end of the acoustic window, wherein the module and the acoustic lens are sealed by the acoustic window and the probe case.

According to an aspect, the ultrasonic probe according to any preceding embodiment, wherein the ultrasonic probe is a convex type ultrasonic probe.

Provided also is an ultrasonic diagnostic device having the ultrasonic probe according to any preceding embodiment, an image processing unit that generates an ultrasonic image based on ultrasonic signals collected by the ultrasonic probe, and a display device for displaying the ultrasonic image.

Provided also is a method for producing an ultrasonic probe transducer element disposed on a base block including a first portion having a first curvature and a second portion having a second curvature with a radius shorter than the first curvature.

The method includes a step for forming a laminate including a transducer on a flexible printed circuit board (FPC) to create a transducer element, the laminate including the transducer including a layer of piezoelectric elements and a step for dicing the laminate including the transducer to form a plurality of grooves, the plurality of grooves including relatively shallow grooves that do not completely cut through the layer of piezoelectric elements and relatively deep grooves that completely cut through the layer of piezoelectric elements, the relatively shallow grooves and the relatively deep grooves being alternately disposed in a first portion of the transducer element, and the relatively deep grooves being contiguously disposed in a second portion of the transducer element.

Provided also is a method for producing an ultrasonic probe module. The method includes a step for preparing the transducer element in accordance with the method according to embodiment 1, a step for preparing the base block, and a step for disposing and bonding the transducer element on the base block such that the first portion of the transducer element is disposed on the first portion of the base block and the second portion of the transducer element is disposed on the second portion of the base block.

Provided also is the method according to the preceding embodiment, wherein the FPC includes wiring and vias connected to the wiring, the laminate including the transducer includes a reflective layer disposed between the layer of the piezoelectric element and the FPC, the reflective layer contains a metal and is conductive, the reflective layer is connected to the via at a position corresponding to the first portion, and the relatively deep grooves cut through at least a portion of the reflective layer.

According to an aspect, the method of any preceding embodiment, wherein the metal of the reflective layer includes tungsten.

According to an aspect, the method of any preceding embodiment, wherein the wiring of the FPC extends in the azimuth direction.

Note that the invention is not limited to the present embodiment, and various modifications are possible without departing from the essence of the invention.

### REFERENCE NUMERALS

1: Ultrasonic diagnostic device
2: Ultrasonic probe
3: Transmission and reception beamformer
4: Echo data processing unit
5: Display processing unit
6: Display unit
7: Operating unit
8: Control unit
9: Storage unit
10: Acoustic window
11, 13: Cross section
12: Acoustic lens
14, 15′: Transducer element
16: Laminate
161: Second acoustic matching layer
162: Ground electrode
163: First acoustic matching layer
164: Piezoelectric element
165: Reflective layer
166: Large width dummy element
167: U-shaped element
168: I-shaped element
171: Section in which active elements are disposed
172: Section in which dummy elements are disposed
173: Section having shallow and deep repeating grooves
174: Section having deep continuous grooves
175: Relatively shallow groove
176: Relatively deep groove
181: Shoulder/second portion
182: Center/first portion
183: Gap
184: Side portion
185: Disconnection location
187: Dicing direction
20: Flexible substrate/FPC
201: Front surface
203: Rear surface
205: Via
211, 213: Dashed line
215: Wiring
22: Base block
231: Upper surface of probe
233: Bottom surface of probe
235: Azimuth direction
237: Elevation direction
24: Probe case
241: Upper surface side portion
242: Bottom surface side portion
26: Cable
28: Module including transducer
30: Inner housing
301: Upper surface side portion
302: Bottom surface side portion
38: Chassis
50: Surface

What is claimed is:

1. An ultrasonic probe transducer element disposed on a base block including a first portion having a first curvature and a second portion having a second curvature with a radius shorter than the first curvature, comprising
a flexible printed circuit (FPC) disposed over the first portion and the second portion and
a laminate including a transducer disposed on the FPC,
wherein
the laminate including the transducer includes a layer of piezoelectric elements,
the laminate including the transducer includes relatively shallow grooves in which the layer of piezoelectric elements is not completely cut and relatively deep grooves in which the layer of piezoelectric elements is completely cut,
the relatively shallow grooves and the relatively deep grooves are alternately disposed at positions corresponding to the first portion, and
the plurality of relatively deep grooves are contiguously disposed at positions corresponding to the second portion.

2. The transducer element according to claim 1, wherein the FPC includes wiring and vias connected to the wiring,
the laminate including the transducer includes a reflective layer disposed between the layer of the piezoelectric element and the FPC,
the reflective layer contains a metal and is conductive,
the reflective layer is connected to the via at a position corresponding to the first portion, and
the relatively deep grooves cut through at least a portion of the reflective layer.

3. The transducer element of claim 2, wherein the metal of the reflective layer includes tungsten.

4. The transducer element according to claim 2, wherein the wiring of the FPC extends in an azimuth direction.

5. The transducer element according to claim 1, wherein the first portion and the second portion are disposed to be aligned in an azimuth direction.

6. The transducer element according to claim 1, wherein the laminate including the transducer includes an acoustic matching layer disposed on a layer of piezoelectric elements.

7. The transducer element according to claim 1, wherein the laminate including the transducer includes a ground electrode layer disposed on a layer of piezoelectric elements.

8. The transducer element according to claim 1, wherein the relatively shallow grooves cut the piezoelectric element across the entire width of the piezoelectric element in an elevation direction, and
the relatively deep grooves also cut the piezoelectric element across the full width of the piezoelectric element in the elevation direction.

9. An ultrasonic probe module, comprising
the transducer element according to claim 1 and
the base block,
wherein
the base block includes a sound absorbing material.

10. The module according to claim 9, wherein the base block includes a pair of shoulders,
the first portion is disposed between the pair of shoulders,
the second portion is disposed on one or both of the pair of shoulders, and
the transducer element extends beyond either or both of the pair of shoulders.

11. The module according to claim 10, wherein the FPC is bonded to the base block without a gap at least at a portion extending from one of the pair of shoulders to the other of the pair of shoulders.

12. An ultrasonic probe, comprising
the transducer element according to claim 1 and
the base block.

13. The ultrasonic probe according to claim 12, including an acoustic lens disposed on the transducer element,
an acoustic window covering the module and the acoustic lens, and
a probe case covering at least a lower end of the acoustic window,
wherein
the module and the acoustic lens are sealed by the acoustic window and the probe case.

14. The ultrasonic probe according to claim 12, wherein the ultrasonic probe is a convex type ultrasonic probe.

15. An ultrasonic diagnostic device, comprising
the ultrasonic probe according to claim 12,
an image processing unit that generates an ultrasonic image based on ultrasonic signals collected by the ultrasonic probe, and
a display device for displaying the ultrasonic image.
